(19) United States
(12) Patent Application Publication
(10) Pub. No.: US 2018/0056814 A1
(43) Pub. Date: Mar. 1, 2018

(54) Pressures Sensor Device for a Car Seat with Wireless Communication

(71) Applicant: Paul Tanyi, Kannapolis, NC (US)

(72) Inventor: Paul Tanyi, Kannapolis, NC (US)

(21) Appl. No.: 15/253,219

(22) Filed: Aug. 31, 2016

(51) Int. Cl. B60N 2/00; B60Q 9/00; B60N 2/28; G08B 21/02

(52) U.S. Cl. CPC B60N 2/002; G08B 21/0205; B60N 2/2881; B60Q 9/00

(57) ABSTRACT

A car seat pressure sensor device with wireless communication includes a wireless transmitter and a pressure sensor assembly. The wireless transmitter is configured for wirelessly communicating with a portable electronic device via a wireless signal. The pressure sensor assembly includes at least one pressure sensor and is interconnected with the wireless transmitter. The pressure sensor assembly is operable to turn on or off the wireless signal from the wireless transmitter. The pressure sensor device is configured to turn on the wireless signal from the wireless transmitter for communication with the portable electronic device when the pressure sensor assembly senses a certain weight, and turn off the wireless signal from the wireless transmitter for communication with the portable electronic device when the pressure sensor assembly does not sense the certain weight.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The instant disclosure generally relates to car seats for children and safety features or accessories for such car seats. More particularly, the instant disclosure relates to a pressure sensor device for a car seat with wireless communication, and a cushion and car seat system with such a pressure sensor device with wireless communication.

### Description of the Related Art

A car seat or a child safety seat (sometimes referred to as an infant safety seat, a child restraint system, a restraining car seat, the like, etc.) are seats designed specifically to protect children from injury or death during collisions. Car seats are purchased and installed by consumers in their vehicle or car. Many regions require children defined by age, weight, and/or height to use a government-approved child safety car seat while riding in a car.

Car seats are legally required in many countries, including the United States, to safely transport children up to the age of 2 or more years in cars and other vehicles. Other car seats, also known as “booster seats,” are required until the child is large enough to use an adult seat belt, like when the child is approximately 4 ft 9 in tall. For example, the child may need to meet five criteria before moving out of the booster seat, including the child's seating position, shoulder belt position, lap belt position, knee position, and ability to sit properly for the length of the trip.

Generally, countries that regulate passenger safety have child safety laws that require a child to be restrained appropriately depending on their age and weight. These regulations and standards are often minimums, and with each graduation to the next kind of safety seat, there is a step down in the amount of protection a child has in a collision. Some countries, such as Australia and the United States, forbid rear-facing child seats in a front seat that has an airbag. A rear-facing infant restraint put in the front seat of a vehicle places an infant's head close to the airbag, which can cause severe head injuries or death if the airbag deploys. As such, most car seats are placed in the back seat of the parent's car and are rearward facing, which puts the baby out of view of the parent or guardian while driving or in the front seat.

One problem that has been occurring throughout the world is babies and children being accidentally left in a car seat. This problem is especially dangerous when the temperature is hot outside the vehicle, where temperatures inside the vehicle become extremely dangerous to babies and children, and can even be deadly. Children and babies are often left in vehicle by accident, as parents or guardians are often in a hurry and are known to be forgetful with everything on their plate as parents or guardians. As discussed earlier, because the car seats are required to be in the back seat and rearward facing, thus out of sight of the driver, it is easy to understand how the parent or guardian may forget that the child is even in the seat when rushed or distracted.

Currently, there is no safety feature or reminder device known that can be included with car seats or added thereto, that is designed to address this issue that would notify the parent or guardian when a child has been accidently left in the car seat.

The instant disclosure of a pressure sensor for a car seat with wireless communication is designed to address at least some aspects of the problems discussed above.

### SUMMARY

Briefly described, in a possibly preferred embodiment, the present disclosure overcomes the above-mentioned disadvantages and meets the recognized need for such a device by providing a pressure sensor device for a car seat with wireless communication, and a cushion and car seat system utilizing such a car seat pressure sensor device with wireless communication.

The pressure sensor device for a car seat with wireless communication generally includes a wireless transmitter and a pressure sensor assembly including at least one pressure sensor. The wireless transmitter may be configured for wirelessly communicating with a portable electronic device (“PED”) via a wireless signal. The pressure sensor assembly may be interconnected with the wireless transmitter and may be operable to turn on or off the wireless signal from the wireless transmitter. Wherein, the pressure sensor device may be configured to turn on the wireless signal from the wireless transmitter for communication with the portable electronic device when the pressure sensor assembly senses a certain weight. In reverse, the pressure sensor device may be configured to turn off the wireless signal from the wireless transmitter for communication with the portable electronic device when the pressure sensor assembly does not sense the certain weight.

One feature of the instant disclosure may be that the certain weight may be configured for detecting the presence of a child on the pressure sensor assembly. With this aspect, the pressure sensor device may be configured to turn on the wireless signal from the wireless transmitter for communication with the portable electronic device when the pressure sensor assembly senses the presence of the child where the portable electronic device may be operable to determine a proximity to the wireless transmitter for notifying a user that the child has been left in the car seat. In reverse, the pressure sensor device may be configured to turn off the wireless signal from the wireless transmitter when the pressure sensor assembly does not sense the presence of the child.

In select embodiments of the car seat pressure sensor device with wireless communication, the pressure sensor assembly may include two or more pressure sensors. The multiple pressure sensors may be connected in series to the wireless transmitter via ribbon wiring. In select embodiments, the pressure sensor assembly may include four pressure sensors connected in series to the wireless transmitter via ribbon wiring having two wires, where the four pressure sensors are oriented in a rectangular shape with each pressure sensor at a corner.

Another feature of the instant pressure sensor device for a car seat with wireless communication may be that the pressure sensor assembly may include a cover enclosing the pressure sensors. In select embodiments, the cover may be a bottom layer bonded to a top layer.

Another feature of the pressure sensor assembly may be the inclusion of a middle component between the ribbon wiring and/or pressure sensors. In select embodiments, the middle component may be a silver paste.

Another feature of the pressure sensor assembly may be the inclusion of an adhesive on the bottom for securing the pressure sensor assembly in a location.

Another feature of the instant disclosure may be that the pressure sensor device for a car seat with wireless communication may be powered by a battery.

Another feature of the instant disclosure may be that the car seat pressure sensor device with wireless communication may include a sensor connector interconnected between the battery and the wireless transmitter. The sensor connector may be operable to connect and disconnect the power from the battery to the wireless transmitter. The sensor connector may be in communication with the pressure sensor assembly for detecting the amount of resistance provided by the pressure sensor assembly. As such, the sensor connector may be configured to connect the battery to the wireless transmitter when the pressure sensor assembly provides a certain resistance. In reverse, the sensor connector may be configured to disconnect the battery to the wireless transmitter when the pressure sensor assembly does not provide the certain resistance.

Another feature of the instant disclosure may be the inclusion of a microprocessor with the pressure sensor device for a car seat. The microprocessor may be for controlling the operation of the pressure sensor device. In select embodiments, the microprocessor may include a memory component for storing wireless communication information.

Another feature of the instant disclosure may be that the car seat pressure sensor device with wireless communication may include a printed circuit board. The printed circuit board may house and provide connections between: the wireless transmitter, the pressure sensor assembly, the sensor connector, the microprocessor including the memory component, other desired components, the like, etc.

Another feature of the instant disclosure may be that the pressure sensor device for a car seat with wireless communication may include a removable case for the printed circuit board. The removable case may be configured for accessing the battery for replacement.

In select embodiments, the pressure sensor device for a car seat with wireless communication may be housed in a removable cushion for a car seat. The removable cushion with the pressure sensor device may be configured for insertion on top of the car seat.

In other select embodiments, the pressure sensor device for a car seat with wireless communication may be built into a car seat.

In another aspect, the instant disclosure embraces a car seat cushion with the pressure sensor device with wireless communication. The car seat cushion may generally include a cushion and the car seat pressure sensor device with wireless communication. The cushion may be for a car seat and configured for insertion on top of the car seat. The pressure sensor device for a car seat with wireless communication may be inserted inside the cushion. The car seat pressure sensor device with wireless communication may be any of the embodiments of the pressure device for a car seat with wireless communication as shown and/or described herein. For example, the pressure device for a car seat with wireless communication may include the wireless transmitter configured for wirelessly communicating with the portable electronic device via its wireless signal, and the pressure sensor assembly interconnected with the wireless transmitter and operable to turn on or off the wireless signal from the wireless transmitter. As such, the car seat cushion may be configured to turn on the wireless signal from the wireless transmitter for communication with the portable electronic device when the pressure sensor assembly senses a certain weight, like the presence of a child, or turn off the wireless signal from the wireless transmitter for communication with the portable electronic device when the pressure sensor assembly does not sense the certain weight, like the presence of the child.

In select embodiments of the cushion, the pressure sensor assembly may be positioned in a bottom of the cushion, and the wireless transmitter may be positioned in a side flap of the cushion.

In another aspect, the instant disclosure embraces a car seat system. The car seat system may generally include the pressure sensor device for a car seat with wireless communication in any of the embodiments shown and/or described herein, and a software program installed on the portable electronic device. The software program may generally be configured to:
continuously search for the wireless signal from the wireless transmitter;
pair with the wireless transmitter when the wireless signal is received;
track a proximity to the wireless transmitter once paired; and
notify a user that the child is still on the car seat pressure sensor device when the proximity to the wireless transmitter is greater than a set distance.

In select embodiments, the software program installed on the portable electronic device may further be configured to store multiple users for each of the pressure sensor devices and associate the software program installed on each of the user's portable electronic devices. In this embodiment, the software program may also send notifications to any or all users when the child has been forgotten in the car seat.

In other select embodiments, the software program installed on the portable electronic device may further be configured to store multiple car seat pressure sensor devices for a car seat with wireless communication for multiple children and provide a name for each stored car seat pressure sensor device.

In other select embodiments, the software program installed on the portable electronic device may further be configured to:
send a notification for when the child is out of the car seat;
send a notification for when the child is in the car seat;
send, display, and/or provide an alert notification for when the child has been forgotten in the car seat; and
repeat the sent, displayed, and/or provided alert notification at a set interval.

In other select embodiments, the software program installed on the portable electronic device may further be configured to:
initially register the user, where the user enters identification information, contact information, and creates a password;
prompts the registered user to find the car seat pressure sensor device to associate the portable electronic device with;
search for the wireless signal from the wireless transmitter of the car seat pressure sensor device that is to be associated with the portable electronic device;
display the found car seat pressure sensor devices;
select the car seat pressure sensor device that is to be associated with the portable electronic device; and
enter a name for the selected car seat pressure sensor device.

In select embodiments of the car seat system of the instant disclosure, the pressure sensor device for a car seat with wireless communication may be housed in a car seat.

In other select embodiments of the car seat system of the instant disclosure, the pressure sensor device for a car seat may be built into a removable cushion for a car seat configured for insertion on top of the car seat.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a schematic top view of the pressure sensor device for a car seat with wireless communication according to select embodiments of the instant disclosure;

FIG. 2A is a schematic perspective view of a removable cushion according to select embodiments of the instant disclosure for placement on top of a car seat with the pressure sensor device from FIG. 1;

FIG. 2B is a schematic top view of the removable cushion from FIG. 2A;

FIG. 3 is a schematic environmental perspective view of a car seat according to select embodiments of the instant disclosure with the pressure sensor device from FIG. 1 with a child seated therein;

FIG. 4 is a schematic diagram of the pressure sensor device for a car seat with wireless communication according to select embodiments of the instant disclosure showing the wireless signal to the portable electronic device for determining the proximity;

FIG. 5 is a schematic top view of the printed circuit board for the wireless transmitter according to select embodiments of the instant disclosure of the pressure sensor device for a car with wireless communication;

FIG. 6 is a schematic diagram of the operation of the car seat system according to select embodiments of the instant disclosure with the pressure sensor device for a car seat with wireless communication; and

FIGS. 7A-7P are example screenshots of the software program installed on the portable electronic device (“PED”) according to select embodiments of the instant disclosure for use with the pressure sensor device for a car seat with wireless communication.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

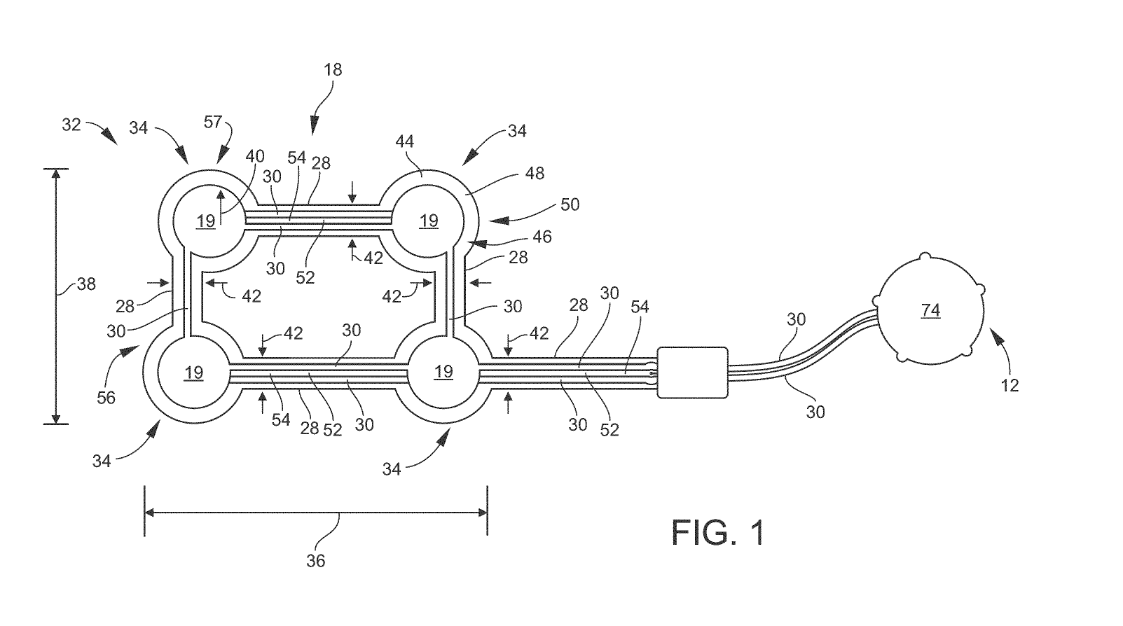

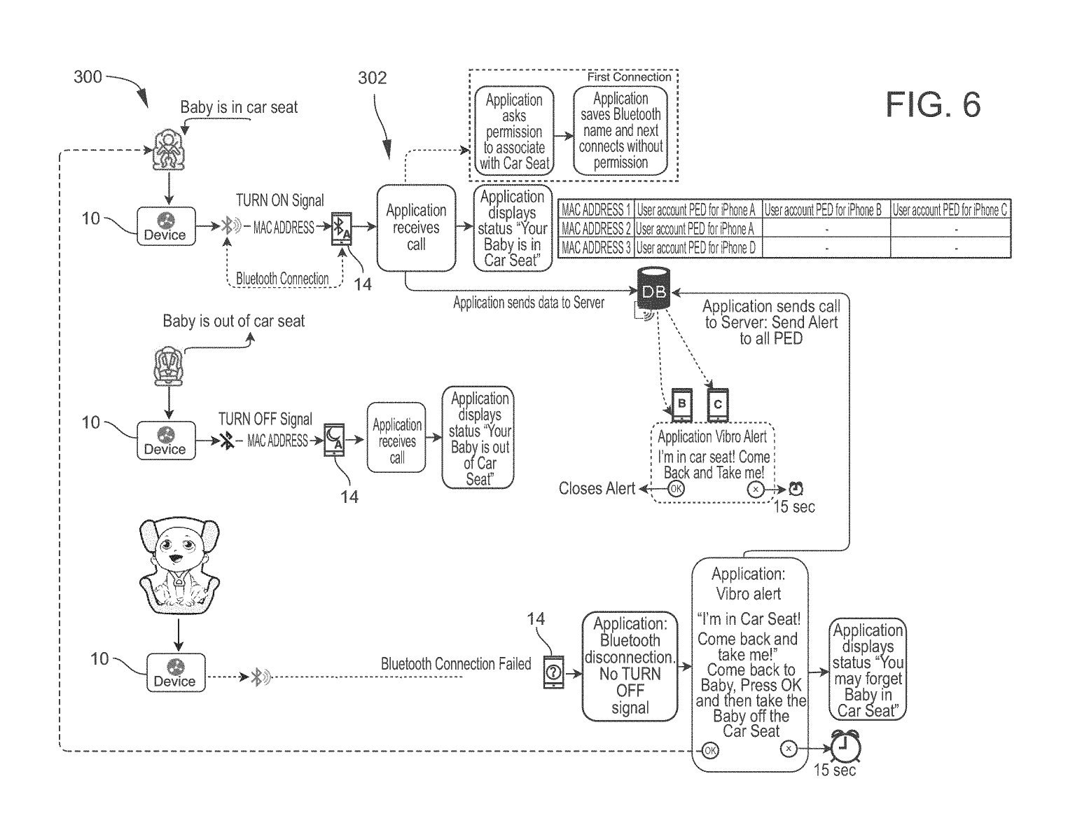

In describing the exemplary embodiments of the present disclosure, as illustrated in FIGS. 1-7, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-5 by way of example, and not limitation, therein is illustrated example embodiments of pressure sensor device 10 for a car seat 200 with wireless communication. Pressure sensor device 10 may be designed for notifying a parent or guardian when a child has been left in car seat 200. Pressure sensor device 10 may generally include wireless transmitter 12 and pressure sensor assembly 18. Wireless transmitter 12 may be configured for wirelessly communicating with portable electronic device 14 (“PED”) via wireless signal 16 (see FIG. 4). Pressure sensor assembly 18 may include at least one pressure sensor 19 and may be interconnected with wireless transmitter 12. Pressure sensor assembly 18 may be operable to turn on or off the wireless signal 16 from wireless transmitter 12. As such, pressure sensor device 10 may be configured to turn on the wireless signal 16 from wireless transmitter 12 for communication with portable electronic device 14 when pressure sensor assembly 18 senses certain weight 20. Likewise, in reverse, pressure sensor device 10 may be configured to turn off wireless signal 16 from wireless transmitter 12 for communication with portable electronic device 14 when pressure sensor assembly 18 does not sense certain weight 20.

As such, car seat pressure sensor device 10 with wireless communication may be configured where certain weight 20 may be for detecting the presence of child 22 on pressure sensor assembly 18. For example, pressure sensor assembly 18 may be configured to sense at least 2 pounds of pressure, or as another example, at least an infant's weight. Whereby, pressure sensor device 10 may turn on wireless signal 16 from wireless transmitter 12 for communication with portable electronic device 14 when pressure sensor assembly 18 senses the presence of child 22. Once the presence of child 22 is sensed by pressure sensor assembly 18 and wireless signal 16 is transmitted by wireless transmitter 12, portable electronic device 14 may be operable to determine its proximity 24 to wireless transmitter 12. Proximity 24 of portable electronic device 14 may then be utilized for notifying user 26 that child 22 has been left in car seat 200 when proximity 24 is greater than set distance 312. As such, portable electronic device may track when the child 22 is in car seat 200 and notify the user 26 when they have left the child in the car seat 200, or walked away from the car seat greater than set distance 312 from wireless transmitter 12. In reverse, pressure sensor device 10 may be configured to turn off wireless signal 16 from wireless transmitter 12 when pressure sensor assembly 18 does not sense the presence of child 22. This may not only conserve the power of wireless transmitter 12 when no child is in the seat, but it will also disconnect the signal to the portable electronic device thereby letting it know that the child 22 is no longer in the car seat 200.

Wireless transmitter 12 may be included in pressure sensor device 10 for car seat 200 with wireless communication. Wireless transmitter 12 may be for communication with portable electronic device 14 of user 26. Wireless transmitter 12 may be any type of wireless transmitter where the proximity to the wireless transmitter may be tracked. In select embodiments, wireless transmitter 12 may be configured for exchanging data over short distances using short-wavelength UHF radio waves in the ISM band from 2.4 to 2.485 GHz. In a possibly preferred embodiment, wireless transmitter 12 may be a low energy Bluetooth® wireless transmitter.

Portable electronic device 14 may be used with pressure sensor device 10 for car seat 200 with wireless communication. Portable electronic device 14 may be any device capable of receiving signals from wireless transmitter 12, including, but not limited to, a mobile or cellular phone, tablet, laptop, key fob, in car infotainment system, the like, etc. In a possibly preferred embodiment, the portable electronic device 14 may be a mobile or cellular phone.

Referring now specifically to FIG. 1, pressure sensor assembly 18 may be included as a component of pressure sensor device 10 for car seat 200 with wireless communication. Pressure sensor assembly 18 may be for detecting certain weight 20, like the presence of child 22 on pressure sensor assembly 18. Pressure sensor assembly 18 may include any device, machine, or combination thereof for sensing the certain weight 20, like the presence of child 22 on pressure assembly 18. In select embodiments, pressure sensor assembly 18 may include two or more pressure sensors 19. The multiple pressure sensors 19 may be wired in pressure sensor device 10 by any means. In select embodiments, the multiple pressure sensors 19 may be connected in series to the wireless transmitter 12 via ribbon wiring 28. In a possibly preferred embodiment, as shown in the figures, pressure sensor assembly 18 may include four pressure sensors 19 connected in series to the wireless transmitter 12 via ribbon wiring 28. The ribbon wiring 28 may have two wires 30 for connecting the pressure sensors 19 in series. The four pressure sensors 19 may be oriented in any desired shape or form in pressure sensor assembly 18.

In a possibly preferred embodiment, as shown in the figures, the four pressure sensors 19 may be oriented in rectangular shape 32 with each pressure sensor at a corner 34. The rectangular shape 32 of the pressure sensors in pressure sensor assembly 18 may be designed for providing a wide area of coverage in the seat of car seat 200. Rectangular shape 32 may have width 36 and height 38, which may be configured for covering a wide area in the seat of car seat 200. For example, and clearly not limited thereto, width 36 of rectangular shape 32 may be approximately 120.0 mm, and height 38 may be approximately 92.8 mm. In select embodiments, each pressure sensor 19 may be circular shaped and may have radius 40. For example, radius 40 may be approximately 15.0 mm. Ribbon wiring 28 may have width 42. In select embodiments, each ribbon wiring 28 may have width 42 of 12.0 mm.

Cover 44 may be included on pressure sensor assembly 18 of pressure sensor device 10 for car seat 200 with wireless communication. Cover 44 may be for enclosing pressure sensor assembly 18, its pressure sensors 19, and its ribbon wiring 28. Cover 44 may enclose pressure sensors 19 and ribbon wiring 28 with bottom layer 46 bonded to top layer 50. For example, bottom layer 46 may be 0.125 mm PET material 48 bonded to top layer 50 of the same 0.125 mm PET material 48.

Middle component 52 may be included in pressure sensor assembly 18 of pressure sensor device 10 for car seat 200 with wireless communication. Middle component 52 may be for providing silver paste 54 between the wires 30 of ribbon wiring 28 and/or between the pressure sensors 19.

Adhesive 56 may also be included on pressure sensor assembly 18 of pressure sensor device 10 for car seat 200 with wireless communication. Adhesive 56 may be for attaching pressure sensor assembly in location 55 on or in car seat 200. Adhesive 56 may be on a portion or all of bottom 57 of pressure sensor assembly 18 for securing pressure sensor assembly 18 in location 55. Adhesive 56 may be any standard adhesive, like an adhesive with a removable backing, which may be provided by 3M corporation of St. Paul, Minn.

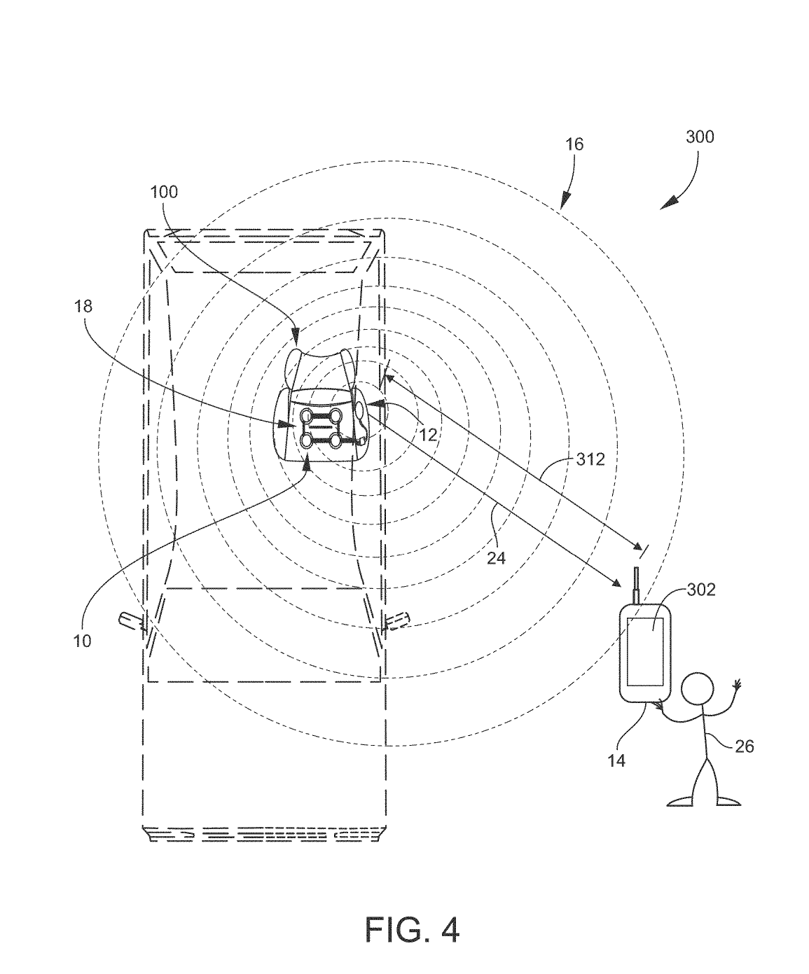

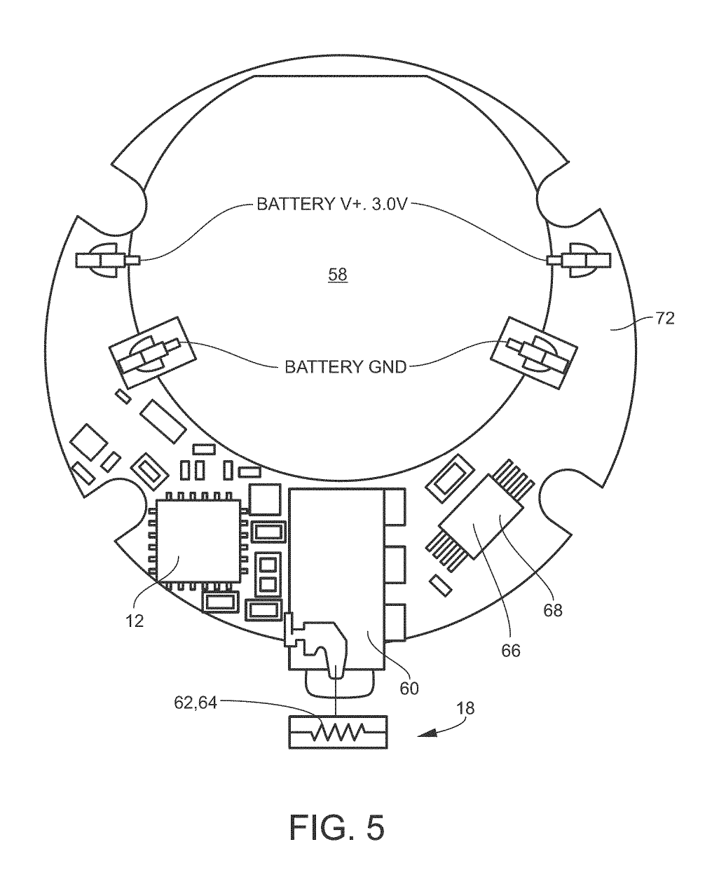

Battery 58 may be included in pressure sensor device 10 for car seat 200 with wireless communication. See FIG. 5. Battery 58 may be for powering pressure sensor device 10 including wireless transmitter 12. Battery 58 may be any battery capable of powering pressure sensor device 10 including wireless transmitter 12. In select embodiments, battery 58 may be a CR2430 battery with volume of 250 mAh.

Sensor connector 60 may be included in pressure sensor device 10 for car seat 200 with wireless communication. See FIG. 5. Sensor connector 60 may be for interconnecting battery 58 to wireless transmitter 12. Sensor connector 60 may be operable to connect and disconnect battery 58 to wireless transmitter 12. Sensor connector 60 may provide connections to pressure sensor assembly 18 for being in communication with pressure sensor assembly 18. As such, sensor connector 60 may be for detecting the amount of resistance 62 provided by pressure sensor assembly 18. Whereby, sensor connector 60 may be configured to connect battery 58 to wireless transmitter 12 when pressure sensor assembly 18 provides certain resistance 64. Similarly, in reverse, sensor connector 60 may be configured to disconnect the power from battery 58 to wireless transmitter 12 when pressure sensor assembly 18 does not provide certain resistance 64.

Microprocessor 66 may be included in pressure sensor device 10 for car seat 200 with wireless communication. See FIG. 5. Microprocessor 66 may be for controlling pressure sensor device 10, including wireless transmitter 12 and sensor connector 60. Microprocessor 66 may include memory component 68 for storing wireless communication information 70.

Printed circuit board 72 may be included in pressure sensor device 10 for car seat 200 with wireless communication. See FIG. 5. Printed circuit board 72 may house and/or provide connections between wireless transmitter 12, pressure sensor assembly 18, sensor connector 60, microprocessor 66 including memory component 68, other desired or needed components, the like, etc. As shown in FIG. 5, printed circuit board 72 and all of its components may be a single chip Bluetooth® smart low energy CSR1010 chip provided by CSR plc of Cambridge, UK

Removable case 74 may be included in pressure sensor device 10 for car seat 200 with wireless communication. See FIG. 5. Removable case 74 may be for enclosing the printed circuit board 72 and all of its components. Removable case 74 may be removable for accessing battery 58 for replacement.

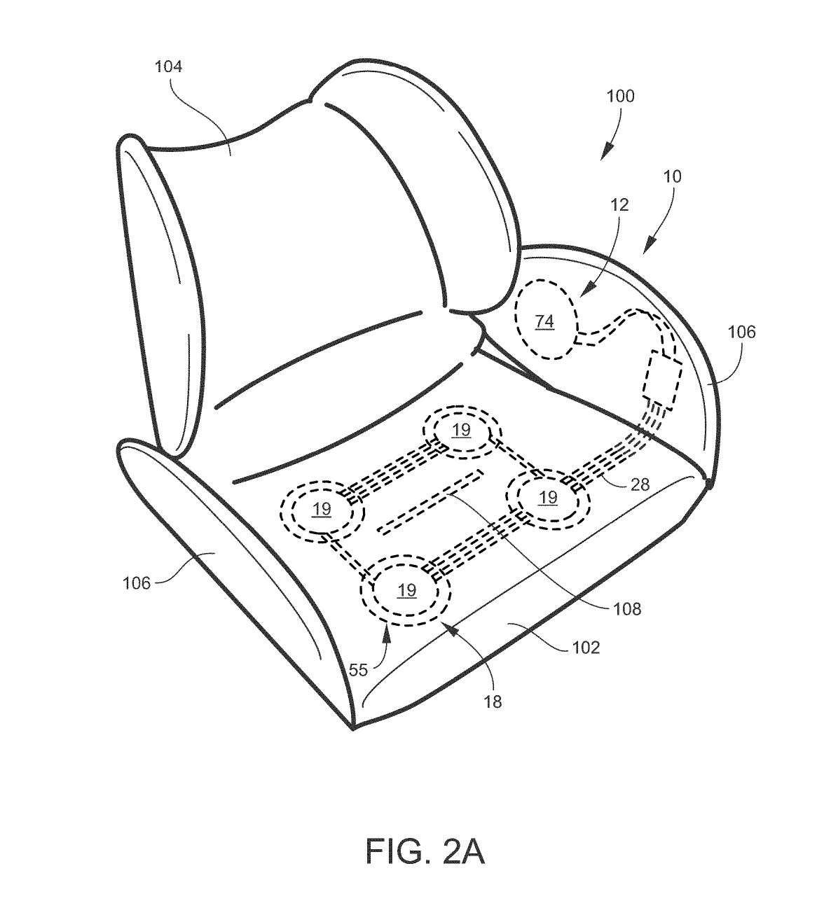

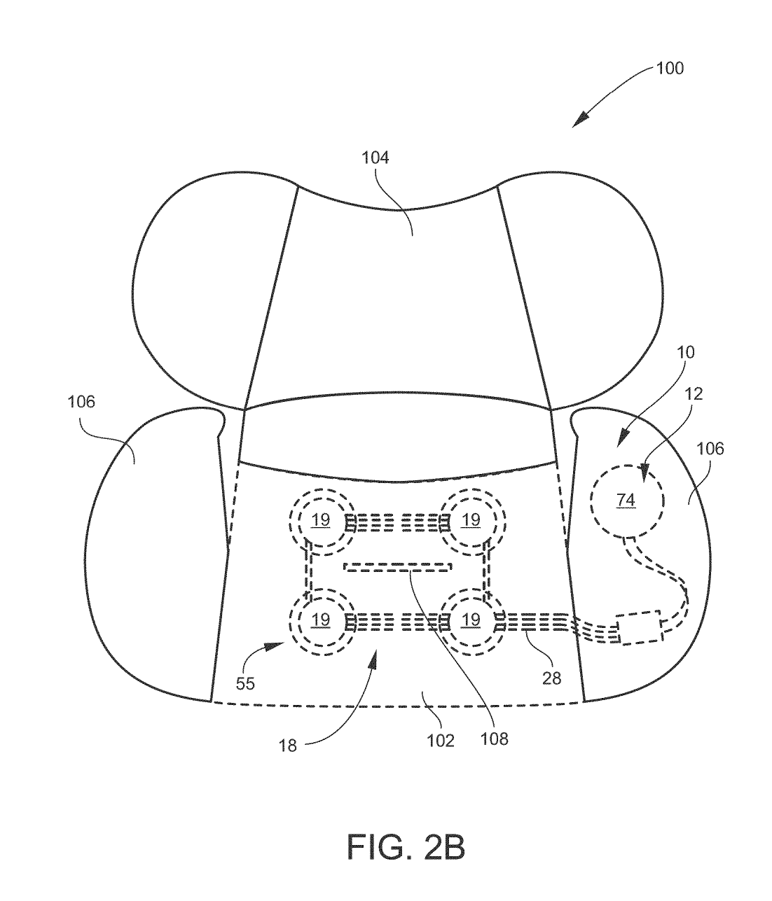

Referring now specifically to FIGS. 2A and 2B, in select embodiments, pressure sensor device 10 for car seat 200 with wireless communication may be included inside removable cushion 100. Removable cushion 100 may be configured for insertion on top of the seat portion of car seat 200. Removable cushion 100 may be an aftermarket product that may be sized and configured to fit specific car seats and manufacturers, or it may be sized and configured to universally fit all or most all of known car seats. In select embodiments, removable cushion 100 may include bottom portion 102 with slot 108 for allowing seat belt connections to pass through. Bottom portion 102 may include pressure sensor assembly 18 inserted therein. In the rectangular shape 32 embodiment of pressure sensor assembly 18, the four pressure sensors 19 may be oriented around slot 108 of bottom portion 102 of removable cushion 100 for covering a wide area on the bottom seat of car seat 200. Removable cushion 100 may also include side flaps 106 that may be for providing side support to child 22 while seated. Printed circuit board 72 including wireless transmitter 12, along with removable case 74, may be housed inside one of side flaps 106. As such, one or both of side flaps 106 may include an opening or access point for replacing battery 58 when needed. Side flaps 106 may also help orient bottom portion 102 in the correction position on the bottom seat of car seat 200. In select embodiments, removable cushion 100 may also include back portion 104 for supporting the lower back of child 22 when seated. Back portion 104 may also help orient bottom portion 102 in the correction position on the bottom seat of car seat 200.

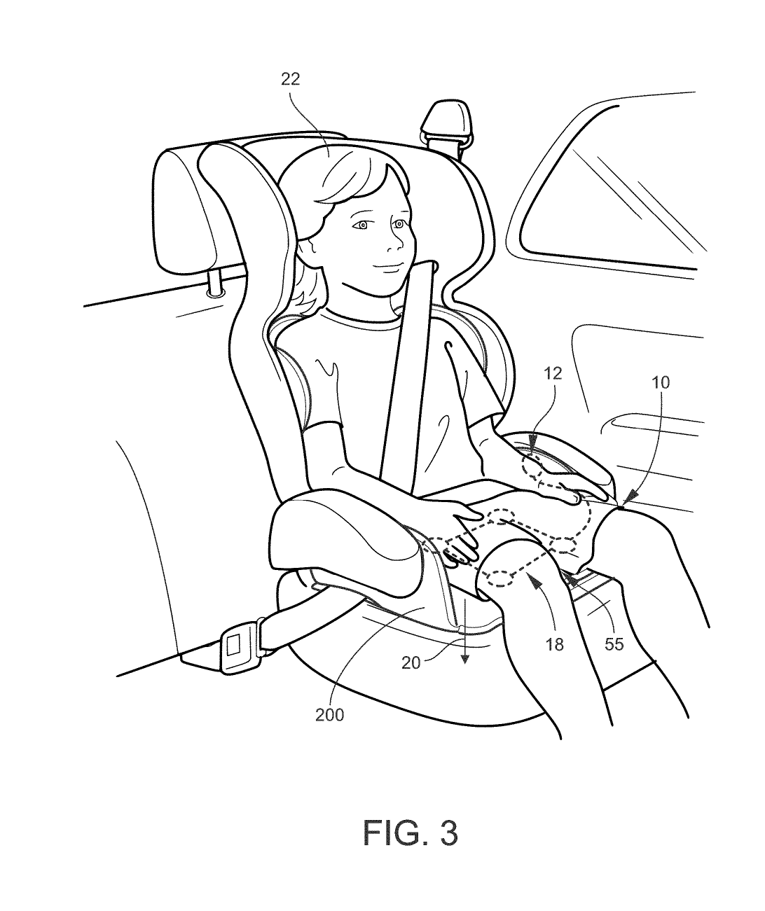

Referring now to FIG. 3, in select embodiments, pressure sensor device 10 for car seat 200 with wireless communication may be manufactured inside car seat 200. In this embodiment, pressure sensor device 10 may be included in the provided cushions of car seat 200, or in any other locations capable of detecting the presence of child 22 on top of pressure sensor assembly 18.

Referring now to FIGS. 4, 6 and 7, car seat system 300 is shown. Car seat system 300 generally includes car seat pressure sensor device 10 with wireless communication (whether installed in removable cushion 100 or manufactured directly in car seat 200), and software program 302 installed on portable electronic device 14. Software program 302 may be designed to allow portable electronic device 14 to communication with wireless transmitter 12 of pressure sensor device 10. During operation, software program 302 may be configured to continuously search (or periodically search, like every couple of second, or any other desired period) for wireless signal 16 from wireless transmitter 12. This will allow portable electronic device 14 (“PED”) to continuously monitor when child 22 is in car seat 200. Software program 302 may also allow portable electronic device 14 to pair with wireless transmitter 12 when wireless signal 16 is received. This pairing feature allows the portable electronic device 14 to lock onto the wireless signal 16 of wireless transmitter 12. Once paired, software program 302 may track proximity 24 of portable electronic device 14 to wireless transmitter 12 (as shown in FIG. 4). During this tracking stage, if proximity 24 is greater than set distance 312, software program 302 may notify user(s) 26 that child 22 is still on car seat pressure sensor device 10. As such, if user 26 leaves the proximity of the car seat greater than set distance 312, like 10 feet, the software program 302 is designed to notify the user 26 that they forgot their child 22 in car seat 200. Once the child is taken out of the seat, portable electronic device 14 will stop receiving wireless signal 16 from wireless transmitter 12 and software program 302 will go back to continuously (or periodically) searching for wireless signal 16 for the next time child 22 is placed in car seat 200.

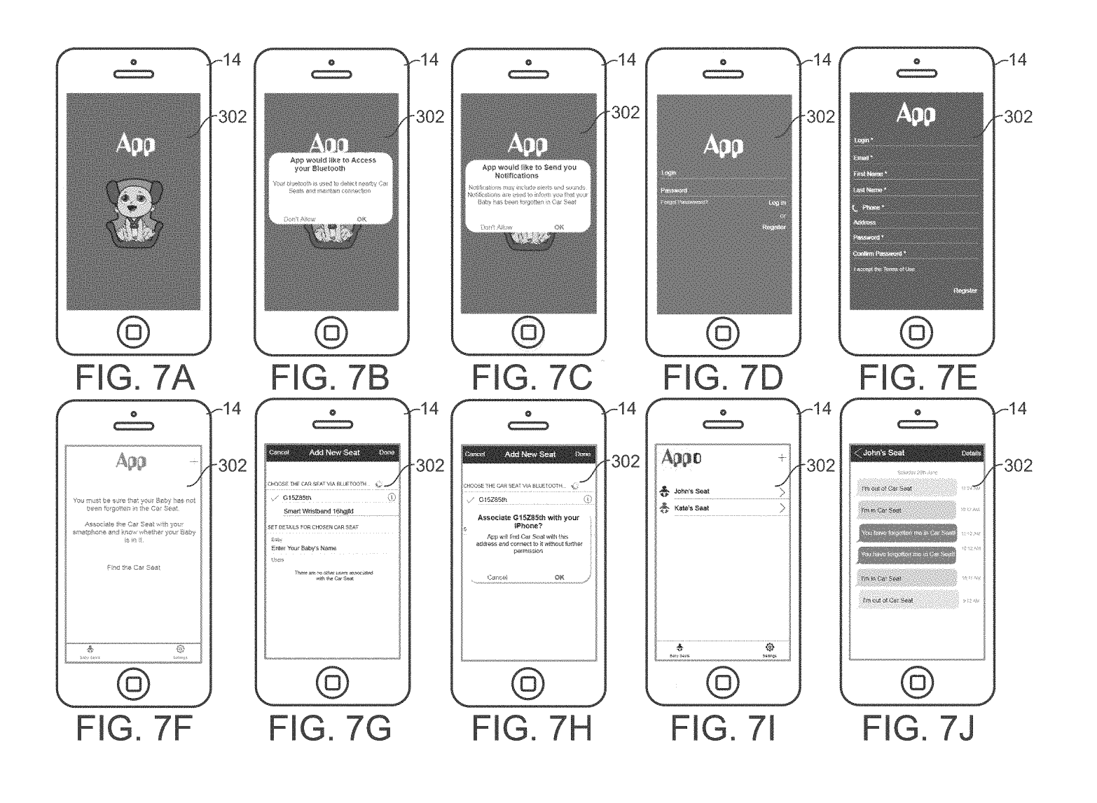

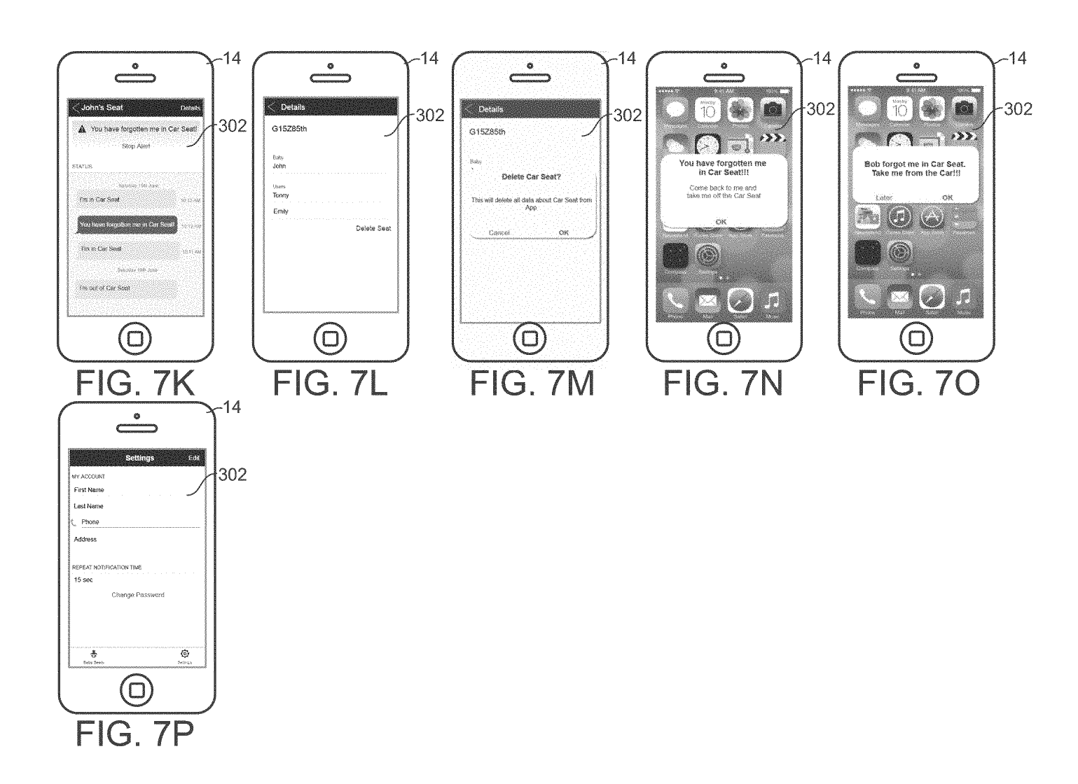

In select embodiments, software program 302 installed on portable electronic device 14 may further be configured to store multiple users for each of the pressure sensor devices 10 and associate the software program installed on each of the user's portable electronic devices 14. See FIG. 7L. As such, software program 302 may be configured to notify each user 26 when child 22 has been forgotten in car seat 200.

In other select embodiments, software program 302 installed on portable electronic device 14 may further be configured to store multiple car seat pressure sensor devices 10 with wireless communication for multiple children and allow a name for each stored car seat pressure sensor device 10. See FIG. 7I.

In select embodiments, software program 302 installed on portable electronic device 14 may further be configured to send a notification for when child 22 is out of the car seat 200, send a notification for when child 22 is in car seat 200 (see FIGS. 7J and 7K), send, display, and/or provide an alert notification for when the child has been forgotten in the car seat (se FIGS. 7J, 7K, 7N and 7O), and repeat the sent, displayed, and/or provided alert notification at a set interval (see FIG. 7P).

In select embodiments, software program 302 installed on portable electronic device 14 may further be configured to initially register the user, where the user enters identification information, contact information, and creates a password (see FIGS. 7D and 7E), prompts the registered user to find the car seat pressure sensor device 10 to associate the portable electronic device 14 with (see FIG. 7F), search for the wireless signal 16 from the wireless transmitter 12 of the car seat pressure sensor device 10 that is to be associated with the portable electronic device (see FIGS. 7F and 7G), display the found car seat pressure sensor devices (see FIG. 7G), select the car seat pressure sensor device 10 that is to be associated with the portable electronic device 14 (see FIG. 7H), and/or enter a name for the selected car seat pressure sensor device 10 (see FIGS. 7G and 7I).

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A car seat pressure sensor device with wireless communication comprising:
a wireless transmitter configured for wirelessly communicating with a portable electronic device via a wireless signal;
a pressure sensor assembly with at least one pressure sensor interconnected with the wireless transmitter and being operable to turn on or off the wireless signal from the wireless transmitter;
wherein, the pressure sensor device is configured to:
turn on the wireless signal from the wireless transmitter for communication with the portable electronic device when the pressure sensor assembly senses a certain weight;
turn off the wireless signal from the wireless transmitter for communication with the portable electronic device when the pressure sensor assembly does not sense the certain weight.

2. The car seat pressure sensor device with wireless communication of claim 1, wherein the certain weight being configured for detecting a presence of a child on the pressure sensor assembly, whereby the pressure sensor device is configured to:
turn on the wireless signal from the wireless transmitter for communication with the portable electronic device when the pressure sensor assembly senses the presence of the child where the portable electronic device is operable to determine a proximity to the wireless transmitter for notifying a user that the child has been left on the pressure sensor device when the proximity is greater than a set distance; and
turn off the wireless signal from the wireless transmitter when the pressure sensor assembly does not sense the presence of the child.

3. The car seat pressure sensor device with wireless communication of claim 1, wherein the pressure sensor assembly comprises two or more pressure sensors connected in series to the wireless transmitter via ribbon wiring.

4. The car seat pressure sensor device with wireless communication of claim 3, wherein the pressure sensor assembly comprises four pressure sensors connected in series to the wireless transmitter via ribbon wiring having two wires, where the four pressure sensors are oriented in a rectangular shape with each pressure sensor at a corner.

5. The car seat pressure sensor device with wireless communication of claim 4, wherein the pressure sensor assembly including:
a cover enclosing the pressure sensors being a bottom layer bonded to a top layer;
a middle component being a silver paste between the two wires of the ribbon wiring and/or between the pressure sensors; and
an adhesive on a bottom of the pressure sensor assembly for securing the pressure sensor in a location.

6. The car seat pressure sensor device with wireless communication of claim 1 further comprising:
a battery;
a sensor connector interconnected between the battery and the wireless transmitter and operable to connect and disconnect the battery to the wireless transmitter;
said sensor connector is in communication with the pressure sensor assembly for detecting a resistance in the pressure sensor assembly, whereby, the sensor connector is configured to:
connect the battery to the wireless transmitter when the pressure sensor assembly provides a certain resistance; and
disconnect the battery to the wireless transmitter when the pressure sensor assembly does not provide the certain resistance; and
a microprocessor for controlling the pressure sensor device, the microprocessor including a memory component for storing wireless communication information.

7. The car seat pressure sensor device with wireless communication of claim 6 further comprising a printed circuit board, the printed circuit board being configured to house and provide connections between:
the wireless transmitter;
the pressure sensor assembly;
the sensor connector; and
the microprocessor including the memory component.

8. The car seat pressure sensor device with wireless communication of claim 7 further comprising a removable case for the printed circuit board, the removable case being configured for accessing the battery for replacement.

9. The car seat pressure sensor device with wireless communication of claim 1 being:
inserted in a removable cushion for a car seat configured for insertion on top of the car seat; or
manufactured into the car seat.

10. A car seat cushion comprising:
the car seat cushion being configured for insertion on top of a car seat; and
a car seat pressure sensor device with wireless communication inserted inside the car seat cushion, the car seat pressure sensor device comprising:
a wireless transmitter configured for wirelessly communicating with a portable electronic device via a wireless signal;
a pressure sensor assembly interconnected with the wireless transmitter and being operable to turn on or off the wireless signal from the wireless transmitter;
wherein, the car seat cushion is configured to:
turn on the wireless signal from the wireless transmitter for communication with the portable electronic device when the pressure sensor assembly senses a certain weight;
turn off the wireless signal from the wireless transmitter for communication with the portable electronic device when the pressure sensor assembly does not sense the certain weight.

11. The car seat cushion of claim 10, wherein the certain weight being configured for detecting a presence of a child on the pressure sensor assembly, whereby the car seat cushion is configured to:
turn on the wireless signal from the wireless transmitter for communication with the portable electronic device when the pressure sensor assembly senses the presence of the child where the portable electronic device is operable to determine a proximity to the wireless transmitter for notifying a user that the child has been left in the car seat when the proximity is greater than a set distance; and
turn off the wireless signal from the wireless transmitter when the pressure sensor assembly does not sense the presence of the child.

12. The car seat cushion of claim 10, wherein the pressure sensor assembly is positioned in a bottom of the car seat cushion, and the wireless transmitter is positioned in a side flap of the car seat cushion.

13. The car seat cushion of claim 10, wherein the pressure sensor assembly comprises four pressure sensors connected in series to the wireless transmitter via ribbon wiring having two wires, where the four pressure sensors are oriented in a rectangular shape with each pressure sensor at a corner, the rectangular shape having a width of approximately 120.0 mm, and a height of 92.8 mm, each pressure sensor having a radius of approximately 15.0 mm, each ribbon wiring having a width of 12.0 mm.

14. The car seat cushion of claim 13, wherein the pressure sensor assembly including:
a cover enclosing the pressure sensor assembly being a bottom layer bonded to a top layer;
a middle component being a silver paste between the two wires of the ribbon wiring and/or between the pressure sensors;
an adhesive on a bottom of the pressure sensor assembly for securing the pressure sensor in a location;
a battery;
a sensor connector interconnected between the battery and the wireless transmitter and operable to connect and disconnect the battery to the wireless transmitter;
said sensor connector is in communication with the pressure sensor for detecting a resistance in the pressure sensor, whereby, the sensor connector is configured to:
connect the battery to the wireless transmitter when the pressure sensor provides a certain resistance; and
disconnect the battery to the wireless transmitter when the pressure sensor does not provide the certain resistance;
a microprocessor for controlling the pressure sensor device, the microprocessor including a memory component for storing wireless communication information;
a printed circuit board, the printed circuit board being configured to house and provide connections between:
the wireless transmitter;
the pressure sensor assembly;
the sensor connector; and
the microprocessor including the memory component; and/or
a removable case for the printed circuit board, the removable case being configured for accessing the battery for replacement.

15. A car seat system comprising:
a car seat pressure sensor device with wireless communication comprising:
a wireless transmitter configured for wirelessly communicating with a portable electronic device via a wireless signal;
a pressure sensor assembly interconnected with the wireless transmitter and being operable to turn on or off the wireless signal from the wireless transmitter;
wherein, the pressure sensor device is configured to:
turn on the wireless signal from the wireless transmitter for communication with the portable electronic device when the pressure sensor assembly senses a child;
turn off the wireless signal from the wireless transmitter for communication with the portable electronic device when the pressure sensor assembly does not sense the child;
a software program installed on the portable electronic device, the software program is configured to:
continuously search for the wireless signal from the wireless transmitter;
pair with the wireless transmitter when the wireless signal is received;
track a proximity to the wireless transmitter once paired; and
notify a user that the child is still on the car seat pressure sensor device when the proximity to the wireless transmitter is greater than a set distance.

16. The car seat system of claim 15, wherein the software program installed on the portable electronic device further being configured to:
store multiple users for each of the pressure sensor devices and associate the software program installed on each of the user's portable electronic devices; and
notify one or all users when the child has been forgotten in the car seat.

17. The car seat system of claim 15, wherein the software program installed on the portable electronic device further being configured to:
store multiple car seat pressure sensor devices with wireless communication for multiple children and provide a name for each stored car seat pressure sensor device.

18. The car seat system of claim 15, wherein the software program installed on the portable electronic device further being configured to:
send a notification for when the child is out of the car seat;
send a notification for when the child is in the car seat;
send, display, and/or provide an alert notification for when the child has been forgotten in the car seat; and
repeat the sent, displayed, and/or provided alert notification at a set interval.

19. The car seat system of claim 15, wherein the software program installed on the portable electronic device further being configured to:
initially register the user, where the user enters identification information, contact information, and creates a password;
prompts the registered user to find the car seat pressure sensor device to associate the portable electronic device with;
search for the wireless signal from the wireless transmitter of the car seat pressure sensor device that is to be associated with the portable electronic device;
display the found car seat pressure sensor devices;
select the car seat pressure sensor device that is to be associated with the portable electronic device; and
enter a name for the selected car seat pressure sensor device.

20. The car seat system of claim 15, wherein the car seat pressure sensor device with wireless communication being:
manufactured in a car seat; or
inserted into a removable cushion for a car seat configured for insertion on top of the car seat.
